(19) United States
(12) Patent Application Publication
(10) Pub. No.: US 2020/0185177 A1
(43) Pub. Date: Jun. 11, 2020

(54) MOLDED CASE CIRCUIT BREAKER

(71) Applicant: LSIS CO., LTD., Anyang-si (KR)

(72) Inventor: Sunkook KIM, Anyang-si (KR)

(21) Appl. No.: 16/585,925

(22) Filed: Sep. 27, 2019

(30) Foreign Application Priority Data
Dec. 11, 2018 (KR) 10-2018-0159412

(51) Int. Cl. H01H 71/02; H01H 71/08

(52) U.S. Cl. CPC H01H 71/0207; H01H 71/08

(57) ABSTRACT

The present disclosure relates to a molded case circuit breaker, and particularly, to a molded case circuit breaker with an insulated cover. A molded case circuit breaker in which a load-side terminal is connected to an external connection device according to an embodiment of the present disclosure includes an insulating cover coupled to an enclosure of the molded case circuit breaker, in which the insulating cover includes an insulating wall interposed between the enclosure and the external connection device.

### CROSS-REFERENCE TO RELATED APPLICATION

Pursuant to 35 U.S.C. § 119(a), this application claims the benefit of earlier filing date and right of priority to Korean Application No. 10-2018-0159412, filed on Dec. 11, 2018, the contents of which is incorporated by reference herein in its entirety.

### FIELD OF THE INVENTION

The present disclosure relates to a molded case circuit breaker, and particularly, to a molded case circuit breaker with an insulated cover.

### BACKGROUND OF THE INVENTION

In general, a molded case circuit breaker (MCCB) is an electric instrument that is installed in part of an electric system to protect the circuit and load by automatically breaking the circuit in an electrical overload state or a short circuit fault.

The molded case circuit breaker generally includes a terminal part that may be connected to a power side or load side, a contact part including a fixed contact and a movable contact that may come in contact with or be separable from the fixed contact to connect or separate the circuit, a switching mechanism that moves the movable contact to supply power required to open/close the circuit, a trip part that detects an over-current or short circuit current at the power side to induce a trip motion of the switching mechanism, and an extinction part that extinguishes an arc occurred in cutting off an abnormal current.

Of the molded case circuit breakers, one connected to the main bus bar of the distribution board is called a plug-in molded case circuit breaker.

FIGS. 1 and 2 illustrate a conventional plug-in molded case circuit breaker. FIG. 1 is a perspective view illustrating that the conventional molded case circuit breaker is installed in a distribution board, and FIG. 2 is a perspective view illustrating that external connection devices are connected to the load-side terminal of the molded case circuit breaker.

The molded case circuit breaker 1 is connected to a bus bar 2 with its power-side terminal 1a, and the load-side terminal 1b is fitted to the distribution board panel 4 by a mounting bracket 3. In the case of a three-phase circuit, the bus bar 2 is arranged in a row of three. The bus bar 2 is mounted side by side on the side of the distribution board panel 4 by a bus bar mounting bracket 2a formed from an insulating material.

The power-side terminal 1a of the molded case circuit breaker 1 is equipped with a connector (not shown) and a finger assembly (not shown) to connect the bus bar 2 to the fixed contactor (not shown). This allows the current to flow from the bus bar 2 to the finger assembly, through the connector and into the interior (fixed terminal) of the molded case circuit breaker 1. The conductive state, i.e. when the handle 5 is rotated to the On-position, the movable contact (not shown) inside the molded case circuit breaker 1 is connected to the fixed contact (not shown) so that the circuit is energized.

The power-side terminal 1a is equipped with a base bus supporter 6 formed of an insulating material to protect internal components from arcs and gases of high temperature emitted from the inside of the breaker during short circuit break and to secure insulation between conductors or from the outside. The base bus supporter 6 functions for maintaining and protecting insulation around the power-side terminal 1a.

The load-side terminal 1b of the molded case circuit breaker 1 may be connected to an external connection device 7 such as a power meter, as shown in FIG. 2. At this time, the connecting bus bar 8 of the external connection device 7 is connected to the load-side terminal (not shown) inside the load side terminal 1b and the molded case circuit breaker 1 and the external connection device 7 are electrically connected to each other.

However, there may be a gap between the molded case circuit breaker 1 and the external connection device 7 for compatibility or to prevent interference, depending on the product. In this case, the connecting bus bar 8 is placed in the space between the load-side terminal 1b and the external connection device 7 of the molded case circuit breaker 1 in an exposed state. Due to this, there is a possibility of insulation breakdown.

### SUMMARY OF THE INVENTION

Therefore, an aspect of the detailed description is to provide a molded case circuit breaker that prevents the possibility of insulation failure occurring at the load-side terminal.

To achieve these and other advantages and in accordance with the purpose of this specification, as embodied and broadly described herein, a molded case circuit breaker having a load-side terminal connected to an external connection device includes: an insulating cover coupled to an enclosure of the molded case circuit breaker, in which the insulating cover includes an insulating wall interposed between the enclosure and the external connection device.

Here, the insulating cover is equipped with side walls covering the side of the load-side terminal.

In addition, the insulation wall includes a partition wall that is formed at an inner portion of the insulating wall to protrude and inserted into a recess formed on an inter-phase partition wall of the load-side terminal.

In addition, the partition wall includes a protrusion that is formed an end portion of the partition wall and coupled by fitting to a fixing part formed at an end of the inter-phase partition wall.

In addition, the insulating partition wall includes an opening through which a terminal of the load-side terminal is exposed.

In addition, an insertion part is formed on a contact portion between the insulating wall and the partition wall, through which a coupling part formed to protrude on a front face of the external connection device is inserted.

In addition, a monitoring hole is formed on the upper face of the insulating cover to identify the internal condition of the load-side terminal.

In addition, a cover opening is formed on the upper part of the enclosure so that the upper cover provided at the upper part of the enclosure can be exposed.

In addition, a protruding front cover covering the upper support of the base bus supporter that is fitted to the front of the enclosure is formed on the front of the insulating cover.

According to the molded case circuit breaker in accordance with one embodiment of the present disclosure, any exposure space does not exist even when external connection devices are connected to the load-side terminal, preventing insulation damage by the connecting bus bars etc.

### BRIEF DESCRIPTION OF THE DRAWINGS

FIG. 1 is a perspective view illustrating a conventional molded case circuit breaker in which the molded case circuit breaker is installed in a distribution board.

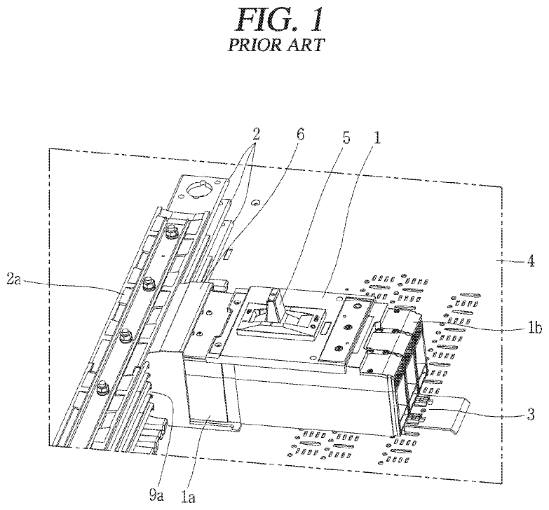

FIG. 2 is a perspective view illustrating the molded case circuit breaker of FIG. 1, in which an external connection device is connected to the load-side terminal of the molded case circuit breaker.

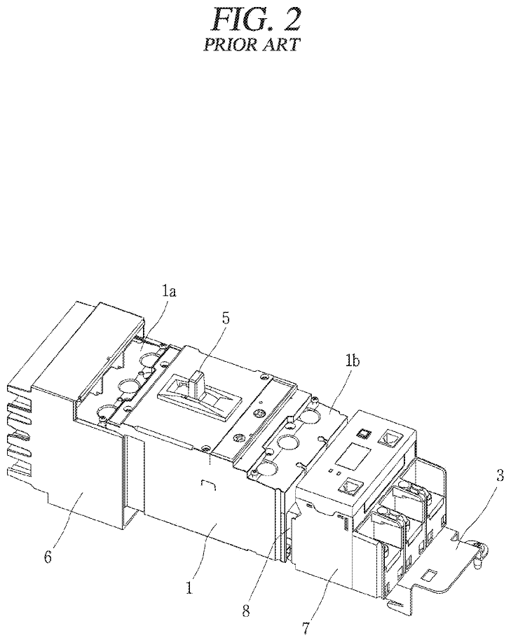

FIG. 3 is a perspective view of a molded case circuit breaker in accordance with the present disclosure in an assembled state of the molded case circuit breaker and the external connection device.

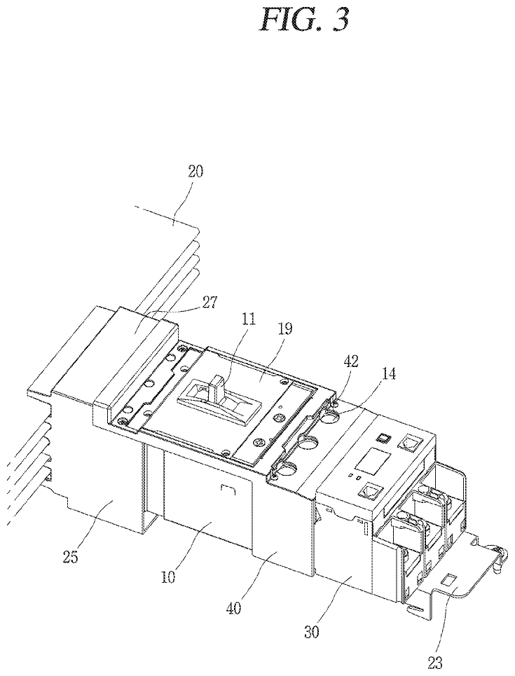

FIG. 4 is a perspective view of a molded case circuit breaker in accordance with the present disclosure in a disassembled state of an insulating cover and the external connection device of FIG. 3.

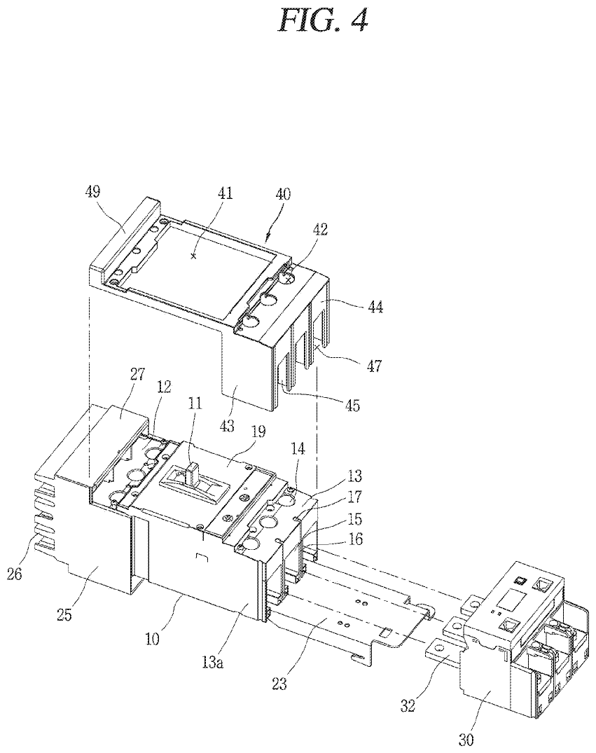

FIG. 5 is a perspective view of a molded case circuit breaker in accordance with an embodiment of the present disclosure in which an insulating cover is coupled to the molded case circuit breaker.

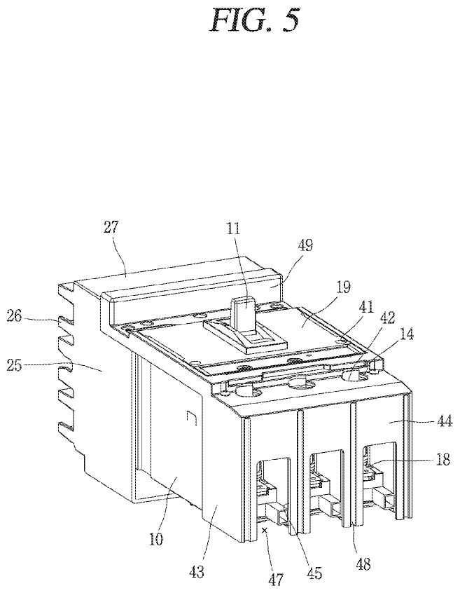

FIG. 6 is a perspective view of an insulating cover applied to a molded case circuit breaker in accordance with an embodiment of the present disclosure.

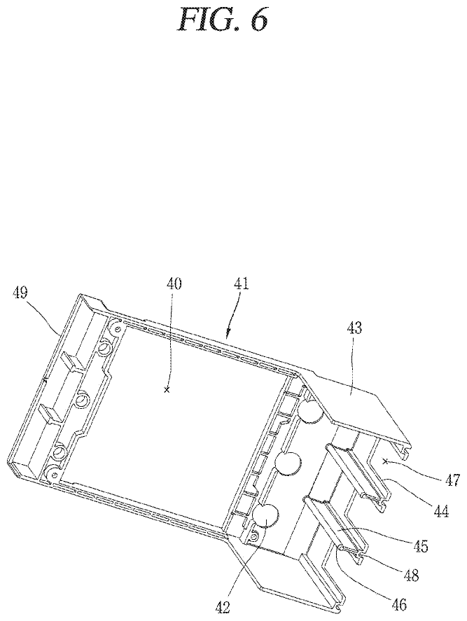

FIG. 7 is a bottom view of FIG. 3.

FIG. 8 is a bottom view of FIG. 5.

FIG. 9 is a perspective view of an external connection device connected to a molded case circuit breaker in accordance with an embodiment of the present disclosure.

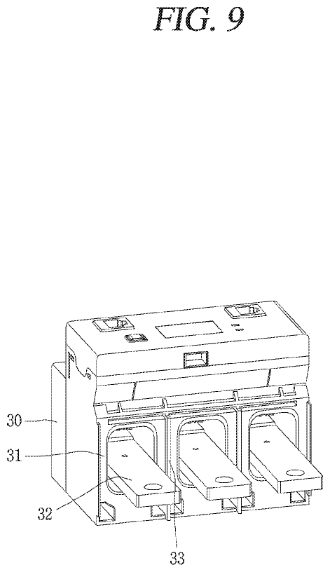

FIG. 10 is a perspective view of an insulating cover applied to a molded case circuit breaker in accordance with another embodiment of the present disclosure.

### DETAILED DESCRIPTION OF THE INVENTION

Hereinafter, preferred embodiments of the present invention will be described with reference to the accompanying drawings, so that a person skilled in the art can easily carry out the invention. It should be understood that the technical idea and scope of the present invention are not limited to those preferred embodiments.

Referring to the accompanying drawings, description will be given in detail of a molded case circuit breaker in accordance with each embodiment of the present disclosure.

The molded case circuit breaker having a load-side terminal 13 connected with an external connection device 30 in accordance with one embodiment of the present disclosure includes an insulating cover 40 coupled to an enclosure 10 of the molded case circuit breaker, and the insulating cover 40 includes an insulating wall 44 interposed between the enclosure 10 and the external connection device 30.

The enclosure 10 of the molded case circuit breaker is constructed approximately into a boxed shape of a cube. The top of the enclosure 10 is equipped with a handle 11 to operate the switching mechanism. The handle 11 may be rotated to the On-position, the Off-position, and the Reset-position.

The front part of the enclosure 10 is provided with a power-side terminal 12 that may be connected to the power line, and the rear (right side of the drawing) is provided with a load-side terminal 13 that may be connected to the load. The upper surface of the power-side terminal 12 and the upper surface of the load-side terminal 13 form an assembly hole 14 so that the load may be assembled and monitored on the terminal side, respectively.

A contact part is provided inside the enclosure 10. The contact part is provided with a fixed contact (not shown) and a movable contact (not shown) that may be contacted or separated by the action of the switching device including the handle 11 to connect or disconnect the circuit.

Multiple bus bars 20 are installed on a panel (not shown) of a distribution board. For three-phase circuits, the bus bars 20 may be installed in parallel. The main current flowing through the bus bars 20 will flow in the load through the molded case circuit breaker.

The load-side terminal 13 of the enclosure 10 is secured to the panel of the distribution board by a mounting bracket 23.

The load-side terminal 13 is provided with an inter-phase partition wall 15. The inter-phase partition wall 15 is provided with a recess along the direction of height at the end. The inner part of the recess 16 is provided with a fixing part 17. The insulating cover 40 is inserted into the recess 16 and the fixing part 17 and secured therebetween.

The upper part of the enclosure 10 is provided with an upper cover 19. In some cases, the enclosure 10 is referred to as a case, and the case and cover are collectively referred to as the enclosure.

The power-side terminal 12 is provided with a connection member for connecting the power-side terminal (which may be integrated with the fixed contacts) extended from the fixed contact (not shown) to the bus bar 20. The connection member may consist of connectors (not shown) and finger assemblies (not shown).

As shown above, the molded case circuit breakers that may be connected to the bus bar are also called a plug-in molded case circuit breaker.

A base bus supporter 25 is provided to protect the connection member between the power-side terminal 12 and the bus bar 20 and maintain insulation with the outside. The base bus supporter 25 is formed of an insulating material.

The base bus supporter 25 is fixed to the power-side terminal 12 so as to cover the connecting member. The base bus supporter 25 may be formed in the form of a box which is open at the rear as a whole.

An entry part 26 is provided at the front of the base bus supporter 25. The entry part 26 may be formed in the form of multiple teeth from the side to allow fit between the bus bar 20. These teeth may be formed to be engaged in the bus bar 20.

An upper support 27 is provided on the upper part of the base bus supporter 25. The upper support 27 has an accommodation space, and an inter-phase partition wall is provided in the accommodation space.

A mounting bracket 23 is provided. The mounting bracket 23 is installed on the distribution board panel and secures the enclosure 10 of the molded case circuit breaker and the external connection device 30.

The external connection device 30 is installed at the load-side terminal 13. The external connection device 30 may be a power meter that measures the amount of power.

A device terminal 31 of the external connection device 30 is exposed to the connecting bus bar 32 for each phase. The connecting bus bar 32 may be connected to a terminal 18 of the load-side terminal 13.

A coupling part 33 protrudes between each phase of the device terminal 31 of the external connection device 30. An insulating cover 40 is fitted to the coupling part 33.

The insulating cover 40 is provided to prevent insulation failure of the connecting bus bar 32, which is exposed to the space between the molded case circuit breaker and the external connection device 30. The insulating cover 40 is fitted to the enclosure 10 of the molded case circuit breaker. The insulating cover 40 is fitted in a downward direction from the top of the enclosure 10.

The insulating cover 40 is provided with a cover opening 41 so that the top cover 19 of the molded case circuit breaker may be exposed. The user can operate the handle 11 through the cover opening 41.

The top face of the insulating cover 40 is constructed with a monitoring hole 42 to provide access to the assembly hole 14. The monitoring hole 42 is formed on the front and rear sides respectively to connect to the assembly hole 14 on the power-side terminal 12 and the assembly hole 14 on the load-side terminal 13. Users can visually determine the assembly status of the terminal through the monitoring hole 42 and the assembly hole 14. In addition, the user can check the temperature status of the terminal through the monitoring hole 42 and the assembly hole 14 using equipment such as a thermometer or a thermal infrared camera.

The insulating cover 40 is provided with sidewall 43 on the side of the rear. The sidewall 43 covers the side 13a of the load-side terminal 13. It is desirable that the sidewall 43 is formed in such a size that it covers the side 13a of the load-side terminal 13. In other words, it is desirable for the sidewall 43 to form more than the width and height of the load-side terminal. As a result, insulation is improved.

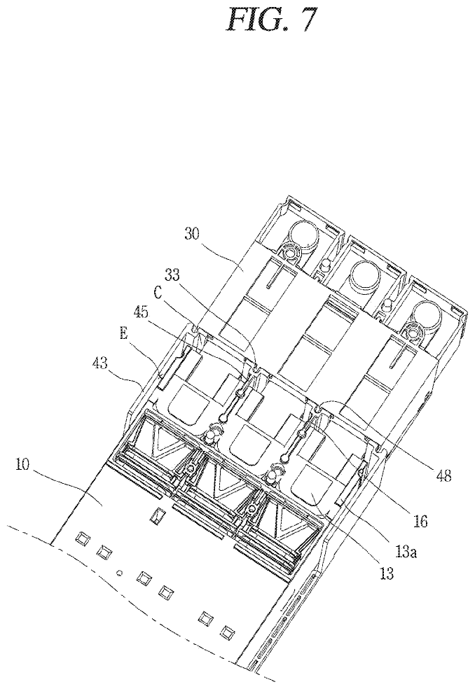

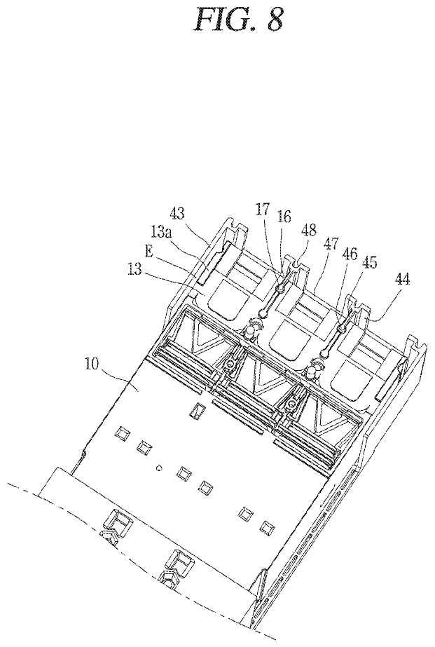

The sidewall 43 has a specified gap from the side 13a of the load-side terminal 13 (see FIGS. 7 and 8). Accordingly, an outlet passage (E) is provided for the leakage of gas or foreign substances from the arc or electric spark that occurs at the load-side terminal 13 or the connecting bus bar 32.

The insulating wall 44 is provided at the rear of the insulating cover 40. The insulating wall 44 is disposed between the enclosure 10 and the external connection device 30 to improve insulation.

A gap (C) of a certain distance occurs between the load-side terminal 13 and the insulating wall 44 (see FIGS. 7 and 8). This gap serves as a gas outlet and also maintains the distance between the molded case circuit breaker and the external connection device 30.

The insulating wall 44 has a protruding partition wall 45 that is inserted into a recess 16 of an inter-phase partition wall 15 of the load-side terminal 13. The partition wall 45 is prepared and extended to the inter-phase partition wall 15 of the load-side terminal 13. Accordingly, the connecting bus bar 32 of the external connection device 30 is closed to the space surrounded by the partition wall 45 and the insulating wall 44 for each phase.

At the end of the partition wall 45, a protrusion 46 is formed, which is fitted into the fixing part 17 of the inter-phase partition wall 15. The protrusion 46 may be formed in the form of a circular or polygon. The protrusion 46 is formed thicker than the thickness of the partition wall 45. The insulating cover 40 may only be fitted or removed in the upper and lower directions, without detaching forward or backward by means of the protrusion 46.

On the insulating wall 44, a terminal opening 47 is formed so that the terminal 18 of the load-side terminal 13 may be exposed. The terminal opening 47 is prepared for each phase. The terminal opening 47 may be formed by grooves that has a certain width and height from the bottom of the insulating wall 44.

Where the insulating wall 44 and the partition wall 45 are in contact, an insertion part 48 is formed that allows the coupling part 33 protruding to the front of the external connection device 30 to be inserted. The coupling part 33 of the external connection device 30 and the insertion part 48 of the insulating cover 40 are inserted and the insulating cover 40 is also fixed with the external connection device 30.

The front of the insulating cover 40 protrudes a front cover 49 covering the upper support 27 of the base bus supporter 25 which is fitted to the front of the enclosure 10. The front cover 49 may be of the shape and size covered by the coupling of a part of the upper support 27 of the base bus supporter 25.

The insulating cover 40 is constructed from the upper support of the base bus supporter 25 equipped on the front of the molded case circuit breaker to the external connection device 30 located on the rear of the molded case circuit breaker, and installed stably, preventing the connecting bus bar 32 of the external connection device 30 from being exposed to damage to insulation.

The insulating cover 40 includes sidewalls 43, which refer to the side 13a of the load-side terminal of the molded case circuit breaker, which improves insulation performance.

The insulating cover 40 creates a gap (E,C) between the side 13a and the rear of the load-side terminal 13, thus inducing the discharge of arc gas or debris.

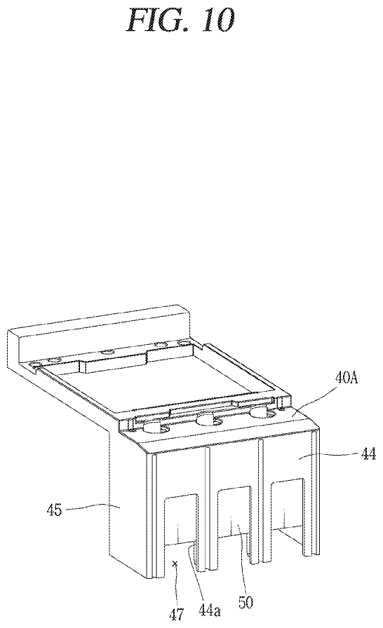

FIG. 10 is a perspective view of an insulating cover applied to a molded case circuit breaker in accordance with another embodiment of the present disclosure.

For this insulating cover 40A, the same reference number is used for the same part as the previous embodiments.

In this embodiment, the insulating cover 40A is provided with a sliding door 50 on the terminal opening 47. The insulating wall 44 is constructed with a door groove 44a along the length direction, and the door groove 44a is fitted with the sliding door 50. The door 50 is placed in a position lowered by the self-weight when no external force is applied. When the insulating cover 40A is fitted to the molded case circuit breaker, the door 50 may be raised by the connecting bus bar 32. As a result, the insulating wall 44 has the effect to be extended to the area tangent to the connecting bus bar 32. This means that insulation performance for the space between the molded case circuit breaker and the external connection device 30 is further improved.

While the invention has been shown and described with reference to the foregoing preferred embodiments thereof, it will be understood by those skilled in the art that various changes and modifications may be made without departing from the spirit and scope of the invention as defined by the appended claims. Therefore, the embodiments disclosed in the present disclosure are not intended to limit the scope of the present disclosure but are merely illustrative, and it should be understood that the scope of the technical idea of the present disclosure is not limited by those embodiments. That is, the scope of protection of the present invention should be construed according to the appended claims, and all technical ideas within the scope of equivalents thereof should be construed as being included in the scope of the present invention.

What is claimed is:

1. A molded case circuit breaker in which a load-side terminal is connected to an external connection device, comprising:
an insulating cover coupled to an enclosure of the molded case circuit breaker, in which the insulating cover includes an insulating wall interposed between the enclosure and the external connection device.

2. The molded case circuit breaker of claim 1, wherein the insulating cover includes side walls covering a side of the load-side terminal.

3. The molded case circuit breaker of claim 1, wherein the insulating wall includes a partition wall formed at an inner portion of the insulating wall to protrude and inserted into a recess formed on an inter-phase partition wall of the load-side terminal.

4. The molded case circuit breaker of claim 3, wherein the partition wall includes a protrusion formed on an end portion thereof and coupled by fitting to a fixing part formed at an end of a recess of an inter-phase partition wall.

5. The molded case circuit breaker of claim 1, wherein the insulating partition wall includes an opening through which a terminal of the load-side terminal is exposed.

6. The molded case circuit breaker of claim 4, wherein an insertion part is formed on a contact portion between the insulating wall and the partition wall, through which a coupling part formed to protrude on a front face of the external connection device is inserted.

7. The molded case circuit breaker of claim 1, wherein a monitoring hole is formed on the upper face of the insulating cover to identify the internal condition of the load-side terminal.

8. The molded case circuit breaker of claim 7, wherein a cover opening is formed on the upper part of the enclosure, through which the upper cover equipped at the upper part of the enclosure is exposed.

9. The molded case circuit breaker of claim 1, wherein a protruding front cover covering the upper support of a base bus supporter coupled to the front of the enclosure is formed on the front of the insulating cover.
